(19) United States
(12) Patent Application Publication
(10) Pub. No.: US 2007/0111707 A1
(43) Pub. Date: May 17, 2007

(54) Method for call-theft detection

(75) Inventors: Itzhak Pomerantz, Kefar Saba (IL); Ishay Pomerantz, Kefar Saba (IL); Carmel Pomerantz, Kefar Saba (IL); Eitan Mardiks, Ra'anana (IL)

Correspondence Address: DR. MARK FRIEDMAN LTD.;C/o Bill Polkinghorn, 9003 Florin Way, Upper Marlboro, MD, 20772, US

(73) Assignee: MSYSTEMS LTD.

(21) Appl. No.: 11/598,601

(22) Filed: Nov. 14, 2006

Related U.S. Application Data
(60) Provisional application No. 60/736,280, filed on Nov. 15, 2005.

(51) Int. Cl. H04M 3/16

(52) U.S. Cl. 455/410

(57) ABSTRACT

The present invention discloses systems and methods for detecting that a phone is being used by a person other than a regular user of the phone, the method including the steps of: (a) comparing a dialed phone number of an outgoing call of the phone to a plurality of reference phone numbers; (b) adjusting an alert level based on whether the dialed phone number is included in the plurality of reference phone numbers; and (c) designating the phone as being used by a person other than the regular user, contingent upon the alert level reaching a predetermined threshold. In some embodiments, the step of adjusting includes adjusting the alert level based on a plurality of dialed phone numbers, wherein each dialed phone number increases the alert level based on the absence of the dialed phone number from the plurality of reference phone numbers.

This patent application claims the benefit of U.S. Provisional Patent Application No. 60/736,280 filed Nov. 15, 2005.

### FIELD AND BACKGROUND OF THE INVENTION

The present invention relates to systems and methods for automatic detection of outgoing calls that are indicative of unauthorized usage of a mobile phone resulting from loss or theft of the mobile phone, or that are indicative of unauthorized usage of a land-line phone (wired or wireless). Furthermore, procedures that can be taken upon such detection to minimize damages due to such unauthorized usage, without inconveniencing an authorized user, are also described.

Mobile phones are often lost or stolen. Mobile phone owners (and authorized users) tend to be negligent in activating mobile-phone security features, such as passwords and personal identification number (PIN) codes. As a result, lost or stolen mobile phones can be used by thieves to make unauthorized calls using the mobile phones (and their associated accounts). Land-line phones may also be used to make unauthorized calls. State-of-the-art methods exist for protecting such phones using static verification of dialed numbers. Calls are blocked that do not fit a pre-determined rule (e.g. the number of digits dialed exceeds a limit), or by using a PIN code as with mobile phones. Some methods checks for the first digits (e.g. block the call if the first digit is zero or one). The methods assume that such calls are long-distance calls, and block the calls because only local calls are allowed. A major differentiation between such prior-art methods and the methods of the present invention is that existing methods do not track previous calls dialed in order to make such blocking decisions based on the history of calls associated with the phone.

During the period that an authorized user is unaware that his/her mobile phone has been lost or stolen, a thief can continue to use the mobile phone to make phone calls. Similarly, an unauthorized user can use a land-line phone located in an office or residence to make phone calls. A thief is usually aware of the limited period of time available before the theft becomes detected and reported by the owner or authorized user, resulting in the mobile phone becoming deactivated. Therefore, it is common for such a thief to use the mobile phone to make a large number of calls during the time that the mobile phone is still activated. Such a high call-volume can lead to substantial expenses being incurred in a relatively short amount of time.

Mobile network operators (MNOs) try to detect irregularly-high phone usage and alert the account holder, but, as there is a variety of phone-usage habits, the MNO normally cannot detect an irregular usage pattern before the account has incurred thousands of dollars of expenses in outgoing calls. Furthermore, since the MNO is selling calls and airtime, the MNO does not have a vested interest in blocking calls. Thus, it is understandable that MNOs in general, through contractual and legal measures, have been passing the responsibility for such unauthorized calls to the account holder.

With the use of subscriber identity modules (SIM cards) in mobile phones and the frequent change of SIM cards when users are traveling between countries (and thus, switching MNOs), the risk of loss or theft is much higher. A thief only needs to obtain a SIM card in order to use the associated account of the SIM card on another mobile phone. When a mobile phone is not in use, the absence of the SIM card is not noticeable. Thus, a mobile phone user may not be aware of a theft for a considerable amount of time.

It would be desirable to have a method for reliably detecting, after a very short period of unauthorized usage that a phone is being used by an unauthorized user, and for blocking outgoing calls and/or allowing a phone network operator (PNO) to take action upon such detection. It would also be desirable if such actions could be automated, without incurring additional costs to the PNO. It would even be more desirable to have a method that enables a PNO to turn such detection methods into a profitable source of business.

### SUMMARY OF THE INVENTION

For the purpose of clarity, several terms which follow are specifically defined for use within the context of this application. The term “dialed phone number” is used in this application to refer to a number that results in a normal call (e.g. call includes conversation between both parties) of normal duration (e.g. >30 sec.) that takes place following the answering of the call. The term “outgoing-call duration” is used in this application to refer to the amount of time elapsed during the call. The term “outgoing-call timestamp” is used in this application to refer to the time of day of the call. The term “dialed-number frequency” is used in this application to refer to the number of times a phone number is dialed in a given amount of time.

Furthermore, the term “unanswered-incoming-call frequency” is used in this application to refer to the number of unanswered incoming calls in a given amount of time. The term “calling rate” is used in this application to refer to the number of calls made in a given amount of time. The term “outgoing-call destination” is used in this application to refer to the region (e.g. the country) to which the call is being made. The terms “phone network operator” and “PNO” are used in this application to refer a general group of network operators including MNOs and land-line network operators. The term “PNO infrastructure” is used in this application to refer to all the hardware and software components of a PNO system except for the phones of the PNO's subscribers. The terms “most recent numbers” and “MRN” are used in this application to refer to phone numbers most recently dialed. The term “MRN list” is used in this application to refer to a list, containing the MRN, that is updated according to pre-defined logical rules that can be either fixed or dynamically altered by a PNO or by a user during system operation.

It is the purpose of the present invention to provide systems and methods for automatic detection of outgoing calls that are indicative of unauthorized usage of a mobile phone resulting from loss or theft of the mobile phone, or that are indicative of unauthorized usage of a land-line phone (wired or wireless). Furthermore, procedures that can be taken upon such detection to minimize damages due to such unauthorized usage, without inconveniencing an authorized user, are also provided.

For the purpose of simplicity, this application describes call-theft detection methods for loss or theft of a mobile phone; however, similar methods can be applied to detect unauthorized usage of a wired or wireless land-line phone where the method protocols can be integrated into a phone base-unit or handset, a private branch exchange (PBX) system, or the system of a PNO.

The methods of the present invention are based on the premise that a normal mobile-phone user tends to call certain numbers frequently, while a thief, who is presumably a stranger to the user, will use the mobile phone to call numbers that are not likely to be the same as the frequently-called numbers of the authorized user.

In a preferred embodiment of the present invention, an MNO provides an account holder with the option to subscribe to a special monitoring service that will alert the account holder if his/her mobile phone is being used to make unauthorized calls. Unauthorized calls are determined based on call-usage patterns associated with the account. Such a subscription option can be offered to the account holder as an insurance plan. Such an insurance plan would release the insured account holder from liability for any unauthorized calls. The subscription option can also be offered to the account holder as a premium-paid plan without release from liability. Such a premium-paid plan has the advantage of reducing unauthorized call charges to the account holder in the case loss or theft of the mobile phone. Actuarial calculations and marketing considerations may indicate to the MNO which plan is the more profitable for such a subscription option.

When an account holder subscribes to such a service, the network system of the MNO keeps the most recent numbers (MRN) that the user has dialed (e.g. the last 30-100 numbers) in a memory, and checks every subsequently dialed phone number to see if the dialed phone number is listed in the MRN list. If the dialed phone number is found in the MRN list, the network system classifies the dialed phone number as an authorized call. If the dialed phone number is not found in the MRN list, the network system sets an alert level. The alert level increases with each additional phone number that is not in the MRN list. The alert level is reset when a phone number that is in the MRN list is dialed. The alert level is also dependent on the call length (i.e. airtime usage) and call cost (factoring in long-distance charges). Calls that are very short, very long, and/or very expensive cause a greater increase in the alert level.

In a preferred embodiment of the present invention, for the case of a “roaming coverage” situation, where the user is making calls through a local MNO that is outside his/her “home” region, since the local MNO does not have the MRN list, the MRN list is stored in the SIM card of the account holder. Thus, the local MNO is able to obtain the MRN list when the mobile phone is being used in the roaming region.

In a preferred embodiment of the present invention, the detection monitoring (i.e. checking the dialed phone number with the MRN list) is done locally by a local processor (i.e. in the SIM card), and the alert to the account holder and/or to the local MNO are issued from the mobile phone. Such an embodiment is applicable to SIM cards with sufficient storage and processing power, such as the MegaSIM™ card, available from msystems Ltd., Kefar-Saba, Israel.

The PIN code of a SIM card is typically registered in the SIM card when the SIM card is provided to the account holder by the MNO. A SIM card usually verifies the PIN code without involvement of the MNO, except for the fact that the MNOs typically require SIM card manufacturers to enforce the use of a PIN code. The present invention allows the PIN-code enforcement to be removed. Using a PIN code each time one turns on his/her mobile phone is cumbersome. The present invention can relieve a user from such a tedious task, and even offer enhanced security, making the life of the account holder (and authorized users of the mobile phone) more comfortable. Therefore, in a preferred embodiment of the present invention, PIN-code enforcement can be bypassed.

Furthermore, in the case where the use of a PIN-code is enforced, the PIN code has been entered by an authorized user, and then the mobile phone has been lost or stolen after the PIN code has been entered, a thief can make unauthorized calls from the mobile phone, since the PIN code does not have to be entered before each call. With the detection method of the present invention operative, such unauthorized calls will be detected as such.

Moreover, the PIN-code enforcement and call-theft detection method can be compared to a day-shift and night-shift door attendant in a secured facility, respectively. The day-shift attendant asks every visitor to show an ID card, looks at the ID card, and then lets the visitor in. The day-shift attendant typically does not attempt to recognize the face of the visitor due to the high volume of visitors during the day. The night-shift attendant checks the ID cards of visitors only until he/she learns the faces of the visitors. After the night-shift attendant is familiar with the visitors, he/she does not ask for the visitors' ID cards anymore. Once familiar with the visitors, the night-shift attendant only looks at the visitors' faces. The “night-shift attendant” approach is more secure because if a trespasser gets hold of a valid ID card, the trespasser will pass the day-shift attendant, but will be blocked by the night-shift attendant.

Thus, returning to the PIN-code enforcement and call-theft detection method, if a thief gets hold of the PIN code of an account holder, the thief will be able to use a stolen mobile phone without any limitations, while if the account holder has the call-theft detection method of the present invention operative on the mobile phone, the thief will be blocked from making an unlimited number of unauthorized calls, even if the thief knows the valid PIN code of the account holder.

Therefore, according to the present invention, there is provided for the first time a method for detecting that a phone is being used by a person other than a regular user of the phone, the method including the steps of: (a) comparing a dialed phone number of an outgoing call of the phone to a plurality of reference phone numbers; (b) adjusting an alert level based on whether the dialed phone number is included in the plurality of reference phone numbers; and (c) designating the phone as being used by a person other than the regular user, contingent upon the alert level reaching a predetermined threshold.

Preferably, the plurality of reference phone numbers includes most recent numbers dialed on the phone.

Preferably, the step of adjusting includes adjusting the alert level based on a plurality of dialed phone numbers, wherein each dialed phone number increases the alert level based on the absence of the dialed phone number from the plurality of reference phone numbers.

Preferably, the step of adjusting includes adjusting the alert level based on factors that are statistically correlated with stolen-phone usage.

Preferably, the factors include at least one factor selected from the group consisting of: an outgoing-call duration, an outgoing-call timestamp, a dialed-number frequency, an unanswered-incoming-call frequency, a calling rate, and an outgoing-call destination.

Preferably, the plurality of reference phone numbers is stored in a PNO infrastructure.

Preferably, the plurality of reference phone numbers is stored in a PBX system.

Preferably, the plurality of reference phone numbers is stored in the phone.

Preferably, the plurality of reference phone numbers is stored in a smartcard installed in the phone.

Preferably, the method further includes the step of: (d) blocking outgoing calls from the phone upon the alert level reaching the predetermined threshold.

Preferably, the method further includes the steps of: (d) verifying if the regular user has physical possession of the phone by an automated challenge-response test initiated by a PNO; and (e) designating the phone as being used by a person other than the regular user, contingent upon a failure of the challenge-response test.

Most preferably, the method further includes the step of: (f) blocking outgoing calls from the phone upon the failure of the challenge-response test.

According to the present invention, there is provided for the first time a smartcard for detection of a phone that is being used by a person other than a regular user of the phone, the smartcard configured: (a) to compare a dialed phone number of an outgoing call of the phone to a plurality of reference phone numbers; (b) to adjust an alert level based on whether the dialed phone number is included in the plurality of reference phone numbers; and (c) to contact a PNO, contingent upon the alert level reaching a predetermined threshold.

Preferably, the smartcard is further configured: (d) upon the alert level reaching the predetermined threshold, to initiate a challenge-response test to verify if the regular user has physical possession of the phone; and (e) to designate the phone as being used by a person other than the regular user, contingent upon a failure of the challenge-response test.

Most preferably, the smartcard is further configured: (f) to block outgoing calls from the phone upon the failure of the challenge-response test.

Preferably, the smartcard is configured so that the regular user can reversibly enable the detection.

Preferably, the plurality of reference phone numbers includes most recent numbers dialed on the phone.

Preferably, the step (b) includes adjusting the alert level based on a plurality of dialed phone numbers, wherein each dialed phone number increases the alert level based on an absence of the dialed phone number from the plurality of reference phone numbers.

Preferably, the step (b) includes adjusting the alert level based on factors that are statistically correlated with stolen-phone usage.

Most preferably, the factors include at least one factor selected from the group consisting of: an outgoing-call duration, an outgoing-call timestamp, a dialed-number frequency, an unanswered-incoming-call frequency, a calling rate, and an outgoing-call destination.

Preferably, the plurality of reference phone numbers is stored in a PNO infrastructure.

Preferably, the plurality of reference phone numbers is stored in a PBX system.

Preferably, the plurality of reference phone numbers is stored in the phone.

Preferably, the plurality of reference phone numbers is stored in the smartcard installed in the phone.

According to the present invention, there is provided for the first time a system for detection of a phone that is being used by a person other than a regular user of the phone, the system including: (a) a memory wherein is stored program code for: (i) comparing a dialed phone number of an outgoing call of the phone to a plurality of reference phone numbers; (ii) adjusting an alert level based on whether the dialed phone number is included in the plurality of reference phone numbers; and (iii) contacting a PNO upon the alert level reaching a predetermined threshold; and (b) a processor for executing the program code, and for contacting the PNO via the phone.

Preferably, the memory further includes program code for blocking outgoing calls from the phone upon the alert level reaching the predetermined threshold.

According to the present invention, there is provided for the first time method of doing business, the method including the steps of: (a) configuring a PNO infrastructure according to the method of claim 1; and (b) offering for sale a PNO service, for detection of a phone that is being used by a person other than a regular user of the phone, using the PNO infrastructure.

Preferably, the PNO service is an insurance plan.

Preferably, the PNO service is a premium-paid plan.

According to the present invention, there is provided for the first time method of doing business, the method including the steps of: (a) providing the smartcard of claim 13; and (b) offering for sale a PNO service, for detection of a phone that is being used by a person other than a regular user of the phone, using the smartcard of claim 13 installed in the phone.

Preferably, the PNO service is an insurance plan.

Preferably, the PNO service is a premium-paid plan.

These and further embodiments will be apparent from the detailed description and examples that follow.

### BRIEF DESCRIPTION OF THE DRAWINGS

The present invention is herein described, by way of example only, with reference to the accompanying drawing, wherein:

FIG. 1 is a simplified flowchart of the operational procedures of the call-theft detection method, according to a preferred embodiment of the present invention;

FIG. 2 is a simplified schematic block diagram of a system configured to operate using the call-theft detection method, according to a preferred embodiment of the present invention.

### DESCRIPTION OF THE PREFERRED EMBODIMENTS

The present invention relates to systems and methods for automatic detection of outgoing calls that are indicative of unauthorized usage of a mobile phone resulting from loss or theft of the mobile phone. The principles and operation for automatic detection of outgoing calls that are indicative of unauthorized usage of a mobile phone, according to the present invention, may be better understood with reference to the accompanying description and the drawing.

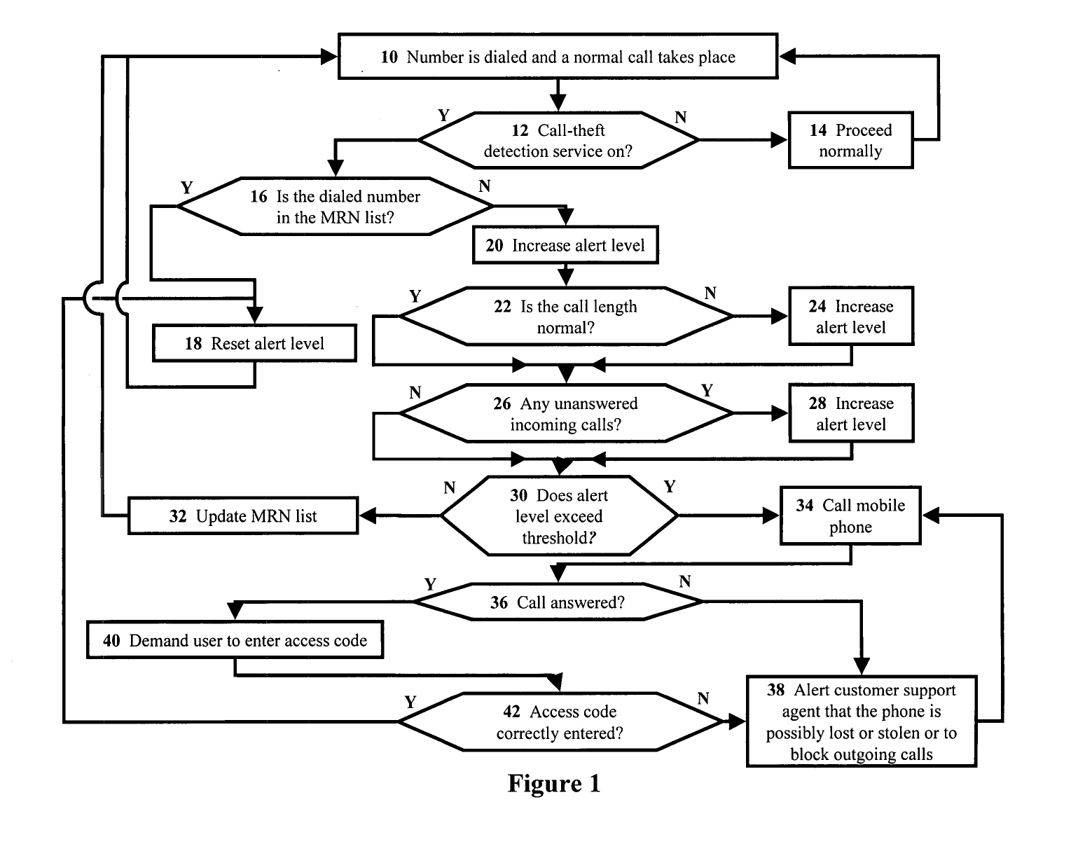

Referring now to the drawings, FIG. 1 is a simplified flowchart of the operational procedures of the call-theft detection method, according to a preferred embodiment of the present invention. A phone number is dialed on a mobile phone, and a normal call takes place (Step 10). The system checks if the account holder of the mobile phone is subscribed to the call-theft detection service (Step 12). The system can be either the network system of the MNO, or a system residing in a smartcard (e.g. a SIM card) installed in the mobile phone. If the service is not activated, then the call is processed normally without any detection monitoring (Step 14).

If the service is activated, then the system checks if the dialed phone number is listed in the MRN list of the mobile phone (Step 16). The MRN list typically contains 30-100 numbers. If the dialed phone number is found in the MRN list, then the system resets the alert level of the mobile phone to zero (Step 18). It should be noted that a number will be considered as “dialed” only if a normal call (e.g. call includes conversation between both parties) of normal duration (e.g. >30 sec.) takes place following the answering of the call. This prevents a thief from imitating calling patterns of an authorized user without actually talking to the user's acquaintances (i.e. hanging up before the calls are answered) to avoid detection by the system.

Once the MRN list has become full, then phone numbers are replaced in the MRN list according to chronology. If a user does not use the phone for an extended period of time (e.g. a month or longer), the MRN list will contain the last current set of phone numbers (i.e. the phone numbers, up to the capacity of the MRN list, that were in the list during the phone's most recent usage). The MRN list can also be a dynamic list, in which newer, frequently-dialed phone numbers replace older phone numbers that are no longer frequently used. Initially, the MRN list is empty. During use, each new dialed phone number is appended to the MRN list, together with some parameters that indicate the calling frequency associated with the phone number (e.g. the number of times the phone number was dialed since being added to the MRN list and the date of last use). When a phone number in the MRN list is dialed again, the date of last use is updated and the number of uses is incremented, for example. When the MRN list is full, then every new phone number that is dialed replaces the least used number in the MRN list. As an example, the criteria for a phone number being “least used” is a combination of the date of last use and the number of times the phone number was used (e.g. a phone number that was dialed only once, or that was last dialed over three weeks ago is a candidate for removal from the MRN list). At any given time, the MRN list contains the most frequently- and recently-used phone numbers.

If the dialed phone number is not found in the MRN list, then the system increases the alert level of the mobile phone by one (Step 20), and checks if the call length to the dialed phone number is “normal” (Step 22). For example, the call length can be defined as normal for international calls less than 15 minutes long, and for domestic calls less than 45 minutes long. The maximum normal call-length can also be user-adjustable. If the call is found to be exceptionally long, then the current alert level of the phone is increased substantially (e.g. multiplied by a factor of two) (Step 24). The system then checks if any unanswered incoming calls (or missed calls) have been received by the mobile phone (Step 26). A thief will normally reject all incoming calls in order not to risk having his/her voice being recorded. If any unanswered incoming calls have been received to the mobile phone, the alert level is increased substantially (Step 28). It is noted that the “substantial alert-level increases” that occur in Steps 24 and 28 can use different multiplication factors.

In other preferred embodiments of the present invention, the alert level is also dependent on factors such as: outgoing-call duration, outgoing-call timestamp, dialed-number frequency, unanswered-incoming-call frequency, calling rate, an outgoing-call destination. Calls that are very short, very long, and/or very expensive cause a greater increase in the alert level. It will be appreciated that a call will already be taking place before the system checks for irregular activity. As previously mentioned, the number of unauthorized calls is reduced as a result of the call-theft detection method. It is noted that the flowchart of FIG. 1 typically has to be iterated more than once to raise the alert level to the threshold. Therefore, Step 26 occurs during and between the outgoing calls that the user is making (i.e. during multiple cycles of the flowchart of FIG. 1) once Step 16 receives a “NO” result until Step 18 (MRN reset) or Step 32 (MRN update) take place. In the case where the user makes a single extremely-long phone call in which the alert level is raised to the threshold, the MNO can intervene in the call (e.g. by advising the account holder to allow “call-waiting”, and to disconnect the call if call-waiting is not answered within a reasonable time).

The system then checks if the alert level of the mobile phone has exceeded a threshold (e.g. an alert level of 6-8) (Step 30). If the alert level has not exceeded the threshold, the system classifies the call as authorized, and adds the dialed phone number to the MRN list as a “candidate” number (Step 32). A candidate number is not included in the check performed in Step 16, but will become a “member” number of the MRN list upon resetting the alert level (Step 18).

If the alert level has exceeded the threshold, then the system classifies the mobile phone as possibly lost or stolen, and makes an automatic call to the mobile phone (Step 34). If the “system” is a system residing in a smartcard installed in the mobile phone, then the smartcard can autonomously initiate the automatic call to the mobile phone. The system then checks for the automated call to be answered (Step 36). If an authorized user does not answer the call, then the system passes the case to a customer support agent of the MNO (Step 38). If an authorized user answers the mobile phone, the system will then automatically challenge the user to enter an access code into the mobile phone (supposedly unknown to the thief) such as a password, PIN, or account number (Step 40).

The system then checks for the access code to be correctly entered (Step 42). If the user enters the access code correctly, then the system resets the alert level to zero (Step 18). The system then classifies the calls as authorized calls, even though the calls do not conform to the “normal” criteria. If the user does not enter the access code correctly, then the system passes the case to a customer support agent of the MNO (Step 38). The customer support agent can then call the mobile phone to verify that an authorized user has the mobile phone in his/her possession (Step 34). If the customer support agent fails to reach an authorized user, the customer support agent can temporarily block outgoing calls, leaving a message that an authorized user has to call the MNO in order to resume the service (Step 38).

It is noted that the system requires an authorized user to make a certain number of phone calls over a certain period of time (e.g. at least 30 calls over two weeks) in order for the system to “learn” the user's normal calling pattern. The method of the present invention has less reliability until such a normal calling pattern is established. Thus, a brand new mobile phone would not have reliable protection upon activation. For this reason, the system can have a “training period” where the alert-level criteria are less stringent in order to avoid the system triggering false alarms.

While the method of the present invention does not guarantee that a lost or stolen mobile phone will be detected, the method provides a greater likelihood that the mobile phone will be detected as lost or stolen after a few unauthorized phone calls have been made, offering the account holder a greater sense of security and comfort.

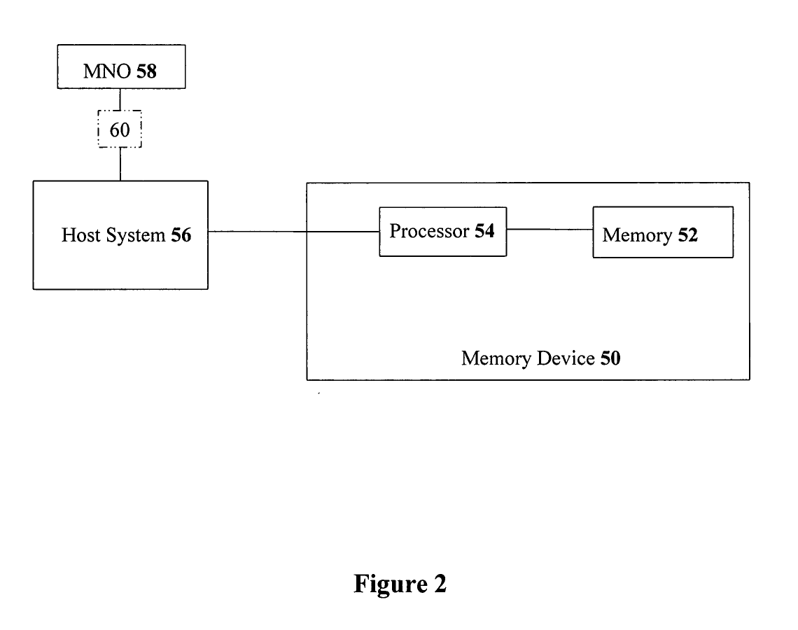

FIG. 2 is a simplified schematic block diagram of a system configured to operate using the call-theft detection method, according to a preferred embodiment of the present invention. A memory device 50, having a memory 52 and a processor 54, is shown operationally connected to a host system 56. As mentioned above, memory device 50 can be a smartcard such as a high-capacity SIM card. Memory device 50 contains program code configured to execute the call-theft detection method via processor 54. Processor 54 uses the communication hardware of host system 56 to call an MNO 60 in case of possible loss or theft of host system 56. RF communications between host system 56 and MNO 58 is shown as a communication channel 60 in FIG. 2.

In a preferred embodiment of the present invention, an MNO provides an account holder with the option to subscribe to a special monitoring service that will alert the account holder if his/her mobile phone is being used to make unauthorized calls. Unauthorized calls are determined based on call-usage patterns associated with the account. Such a subscription option can be offered to the account holder as an insurance plan. Such an insurance plan would release the insured account holder from liability for any unauthorized calls. The subscription option can also be offered to the account holder as a premium-paid plan without release from liability. Such a premium-paid plan has the advantage of reducing unauthorized call charges to the account holder in the case loss or theft of the mobile phone. Thus, the account holder is given two subscription options: a more expensive subscription fee with no liability for unauthorized calls, or less expensive subscription fee with limited liability for unauthorized calls. Actuarial calculations and marketing considerations may indicate to the MNO which plan is the more profitable for such a subscription option.

As noted above, it will be appreciated that the call-theft detection methods described above can be applied to detect unauthorized usage of a wired or wireless land-line phone where the method protocols can be integrated into a phone base-unit or handset, a private branch exchange (PBX) system, or the system of a PNO.

While the invention has been described with respect to a limited number of embodiments, it will be appreciated that many variations, modifications, and other applications of the invention may be made.

What is claimed is:

1. A method for detecting that a phone is being used by a person other than a regular user of the phone, the method comprising the steps of:
(a) comparing a dialed phone number of an outgoing call of the phone to a plurality of reference phone numbers;
(b) adjusting an alert level based on whether said dialed phone number is included in said plurality of reference phone numbers; and
(c) designating the phone as being used by a person other than the regular user, contingent upon said alert level reaching a predetermined threshold.

2. The method of claim 1, wherein said plurality of reference phone numbers includes most recent numbers dialed on the phone.

3. The method of claim 1, wherein said step of adjusting includes adjusting said alert level based on a plurality of dialed phone numbers, wherein each said dialed phone number increases said alert level based on the absence of said dialed phone number from said plurality of reference phone numbers.

4. The method of claim 1, wherein said step of adjusting includes adjusting said alert level based on factors that are statistically correlated with stolen-phone usage.

5. The method of claim 4, wherein said factors include at least one factor selected from the group consisting of: an outgoing-call duration, an outgoing-call timestamp, a dialed-number frequency, an unanswered-incoming-call frequency, a calling rate, and an outgoing-call destination.

6. The method of claim 1, wherein said plurality of reference phone numbers is stored in a PNO infrastructure.

7. The method of claim 1, wherein said plurality of reference phone numbers is stored in a PBX system.

8. The method of claim 1, wherein said plurality of reference phone numbers is stored in the phone.

9. The method of claim 1, wherein said plurality of reference phone numbers is stored in a smartcard installed in the phone.

10. The method of claim 1, the method further comprising the step of:
(d) blocking outgoing calls from the phone upon said alert level reaching said predetermined threshold.

11. The method of claim 1, the method further comprising the steps of:
(d) verifying if the regular user has physical possession of the phone by an automated challenge-response test initiated by a PNO; and
(e) designating the phone as being used by a person other than the regular user, contingent upon a failure of said challenge-response test.

12. The method of claim 11, the method further comprising the step of:
(f) blocking outgoing calls from the phone upon said failure of said challenge-response test.

13. A smartcard for detection of a phone that is being used by a person other than a regular user of the phone, the smartcard configured:
(a) to compare a dialed phone number of an outgoing call of the phone to a plurality of reference phone numbers;
(b) to adjust an alert level based on whether said dialed phone number is included in said plurality of reference phone numbers; and
(c) to contact a PNO, contingent upon said alert level reaching a predetermined threshold.

14. The smartcard of claim 13, wherein the smartcard is further configured:
(d) upon said alert level reaching said predetermined threshold, to initiate a challenge-response test to verify if the regular user has physical possession of the phone; and
(e) to designate the phone as being used by a person other than the regular user, contingent upon a failure of said challenge-response test.

15. The smartcard of claim 14, wherein the smartcard is further configured:
(f) to block outgoing calls from the phone upon said failure of said challenge-response test.

16. The smartcard of claim 13, wherein the smartcard is configured so that the regular user can reversibly enable the detection.

17. The smartcard of claim 13, wherein said plurality of reference phone numbers includes most recent numbers dialed on the phone.

18. The smartcard of claim 13, wherein said step (b) includes adjusting said alert level based on a plurality of dialed phone numbers, wherein each said dialed phone number increases said alert level based on an absence of said dialed phone number from said plurality of reference phone numbers.

19. The smartcard of claim 13, wherein said step (b) includes adjusting said alert level based on factors that are statistically correlated with stolen-phone usage.

20. The smartcard of claim 19, wherein said factors include at least one factor selected from the group consisting of: an outgoing-call duration, an outgoing-call timestamp, a dialed-number frequency, an unanswered-incoming-call frequency, a calling rate, and an outgoing-call destination.

21. The smartcard of claim 13, wherein said plurality of reference phone numbers is stored in a PNO infrastructure.

22. The smartcard of claim 13, wherein said plurality of reference phone numbers is stored in a PBX system.

23. The smartcard of claim 13, wherein said plurality of reference phone numbers is stored in the phone.

24. The smartcard of claim 13, wherein said plurality of reference phone numbers is stored in the smartcard installed in the phone.

25. A system for detection of a phone that is being used by a person other than a regular user of the phone, the system comprising:
(a) a memory wherein is stored program code for:
(i) comparing a dialed phone number of an outgoing call of the phone to a plurality of reference phone numbers;
(ii) adjusting an alert level based on whether said dialed phone number is included in said plurality of reference phone numbers; and
(iii) contacting a PNO upon said alert level reaching a predetermined threshold; and
(b) a processor for executing said program code, and for contacting said PNO via the phone.

26. The system of claim 25, wherein said memory further includes program code for blocking outgoing calls from the phone upon said alert level reaching said predetermined threshold.

27. A method of doing business, the method comprising the steps of:
(a) configuring a PNO infrastructure according to the method of claim 1; and
(b) offering for sale a PNO service, for detection of a phone that is being used by a person other than a regular user of said phone, using said PNO infrastructure.

28. The method of claim 27, wherein said PNO service is an insurance plan.

29. The method of claim 27, wherein said PNO service is a premium-paid plan.

30. A method of doing business, the method comprising the steps of:
(a) providing the smartcard of claim 13; and
(b) offering for sale a PNO service, for detection of a phone that is being used by a person other than a regular user of said phone, using the smartcard of claim 13 installed in said phone.

31. The method of claim 30, wherein said PNO service is an insurance plan.

32. The method of claim 30, wherein said PNO service is a premium-paid plan.
